(19) United States
(12) Patent Application Publication
(10) Pub. No.: US 2019/0359461 A1
(43) Pub. Date: Nov. 28, 2019

(54) DEVICE TO HOLD AND LOCK A SCISSOR JACK SCREW FROM LOOSENING AFTER TIGHTENING

(71) Applicant: Charles Richard Gretz, Coopersburg, PA (US)

(72) Inventor: Charles Richard Gretz, Coopersburg, PA (US)

(21) Appl. No.: 16/420,934

(22) Filed: May 23, 2019

Related U.S. Application Data
(60) Provisional application No. 62/676,775, filed on May 25, 2018.

(51) Int. Cl. B66F 17/00; B66F 1/02

(52) U.S. Cl. CPC B66F 17/00; B66F 3/22; B66F 1/02

(57) ABSTRACT

A jack screw locking device is provided. The jack screw locking device has a general L-shape defined by a key arm and a lock arm. The lock arm provides a lock slot and the key arm provides a key notch. The former is for operatively associating with a scissor jack's jack screw nut in a locked engagement when the key arm is slid between a fork portion of the scissor jack framing, thereby preventing rotation about torque axis of the jack screw nut. In conditions where the jack screw starts unwinding immediately upon removing the crank, the key notch can be used to engage the same jack screw nut in a holding position prior to the crank being removed, thereby temporarily holding the jack screw in order to effectuate the locked engagement via a second jack screw locking device.

### CROSS-REFERENCE TO RELATED APPLICATION

This application claims the benefit of priority of U.S. provisional application No. 62/676,775, filed 25 May 2018, the contents of which are herein incorporated by reference.

### BACKGROUND OF THE INVENTION

The present invention relates to scissor jack locking devices and, more particularly, to a device to hold and lock a scissor jack screw from loosening after tightening.

Scissor jacks are used as leveling stabilizers on the underframe of a Recreation Vehicle (RV). These scissor jacks can gradually loosen after tightening the jack screw (i.e., the jack screw can begin to unwind), thus allowing the RV to bounce undesirably in place during movement inside the RV. Furthermore, in some cases, the jack screw can begin to unwind immediately upon setting when the crank is removed from the jack screw nut, causing sudden loss of the desired setting.

As can be seen, there is a need for a scissor jack locking device to hold and lock a scissor jack screw in place after tightening, preventing undesired loosening. The jack locking device embodied by the present invention provides the ability to stop the immediate unwinding of the jack screw when the crank is removed from the jack screw nut as well as hold the desired setting of the scissor jack before and while the locking feature is applied.

The L-shaped device has a first arm oriented orthogonal to a second arm. The first arm provides a hexagonal opening, while the second arm terminates at an “open end wrench” feature. The second arm of the jack locking device may be inserted into the scissor jack frame so as to prevent rotation of the second arm and thus the crank nut as the and the hexagon opening simultaneously fits over the crank nut in a locked engagement, thus locking the crank nut against the rigid scissor jack frame. Furthermore, if unwinding of the jack screw occurs immediately upon the removal of the crank and before the above-mentioned locked engagement can be applied, two jack locking devices may be simultaneously used as follows: (1) the open-end wrench feature of a first jack locking device may be used to hold the jack screw nut while the crank is removed, and (2) the second jack locking device may be installed over the crank nut and into the scissor jack frame, so as to enable removing the first jack locking device that was used as a wrench in step (1).

Thereby, the “open end wrench” feature provides both an all-in-one capability, when using only one jack locking device, as well as a combinational feature for using two jack locking devices in concert. The product embodied by the present invention may be offered as a set of four identical devices, applicable for each corner scissor jack of an RV.

### SUMMARY OF THE INVENTION

In one aspect of the present invention, a jack screw locking device including the following: a lock arm providing a generally centrally disposed lock slot, wherein the lock slot is defined by a hexagonal opening; a key arm orthogonally joined to the lock arm; and a key slot provided at a distal end of the key arm, wherein the key slot is defined by a semi-hexagon notch; and the lock slot and key slot are dimensioned and adapted to operatively associate with a jack screw nut of a scissor jack.

In another aspect of the present invention, a method of positioning a scissor jack in a locked engagement, including a following: providing an above-mentioned jack screw locking device providing a scissor jack having a jack screw with a jack screw nut, wherein a frame of the scissor jack has a forked portion that operatively associates with the jack screw; sliding the key arm between the forked portion; and operatively associating the lock slot with the jack screw nut, wherein if the jack screw unloosens prior to establishing a locked engagement with said jack screw locking device, an user may provide a second jack screw locking device; and prior to sliding the key arm of said jack screw locking device, operatively engaging the jack screw nut and the key slot of the second jack screw locking device in a holding position.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention, illustrating installation;

FIG. 3 is a perspective view of an exemplary embodiment of the present invention, illustrating a locked engagement;

FIG. 4 is a section view of an exemplary embodiment of the present invention, taken of FIG. 3, with a jack element simplified for clarity;

FIG. 5 is a perspective view of an exemplary embodiment of the present invention, showing a key arm 18 being installed with a crank 26;

FIG. 6 is a perspective view of an exemplary embodiment of the present invention, showing a key 18 in a holding position;

FIG. 7 is a perspective view of an exemplary embodiment of the present invention, showing the crank 26 removed and a key arm 22 holding the jack screw 22 tight in the holding position, while a lock slot 14 of another jack screw locking device 10 is installed in the locked engagement; and

FIG. 8 is a perspective view of an exemplary embodiment of the present invention, illustrating the removal of the holding position once the lock slot 14 is installed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a jack screw locking device. The jack screw locking device has a general L-shape defined by a key arm and a lock arm. The lock arm provides a lock slot and the key arm provides a key notch. The former is for operatively associating with the jack screw nut in a locked engagement when the key arm is slid between a fork portion of the scissor jack framing, thereby preventing rotation about torque axis of the jack screw nut. The key notch can be used to engage the same jack screw nut prior to the crank being removed, thereby temporarily holding the jack screw in order to effectuate the locked engagement via a second jack screw locking device in conditions where the jack screw starts unwinding immediately upon removing the crank.

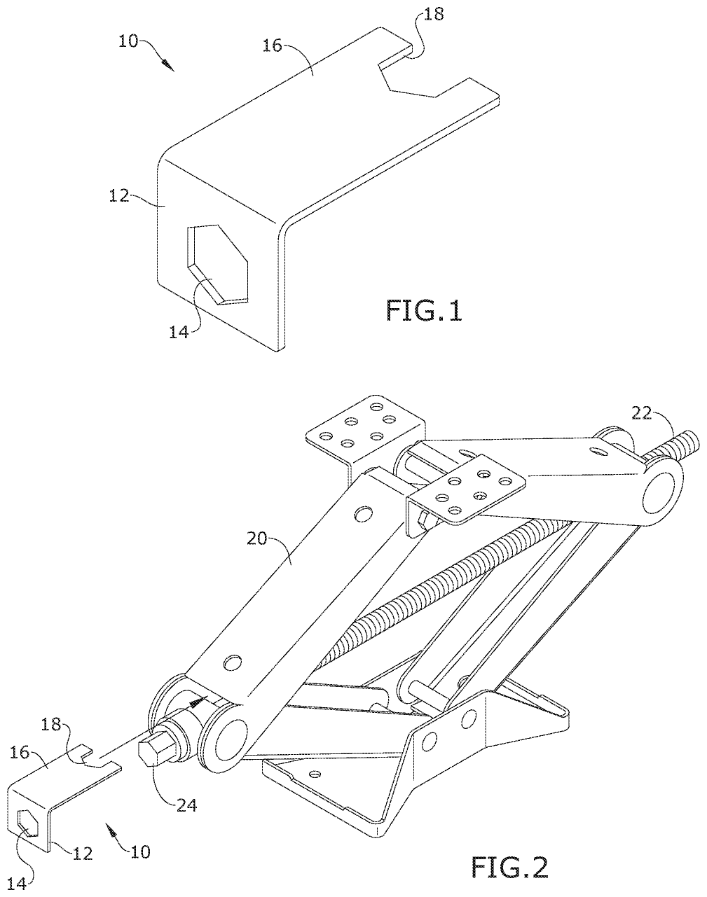

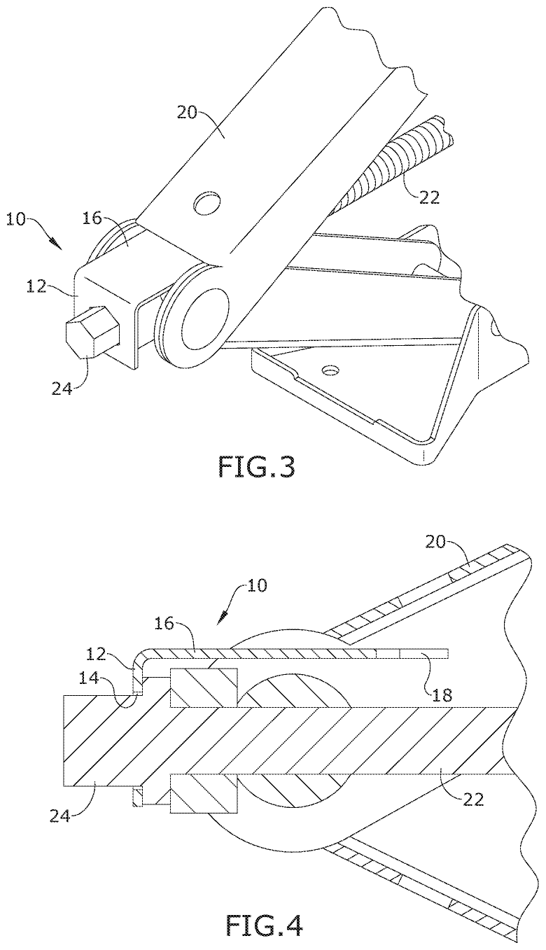

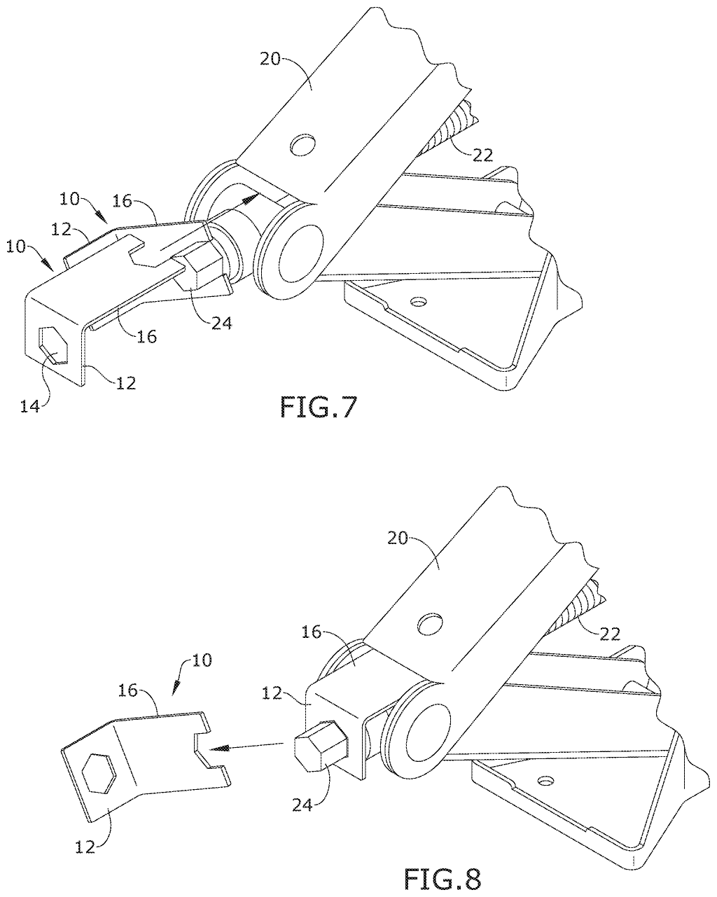

Referring to FIGS. 1 through 8, the present invention may include a jack screw locking device 10 for holding and locking a scissor jack screw 22 from loosening after tightening.

The jack screw locking device 10 may have a lock arm 12 and a key arm 16 oriented orthogonal relative to each other so as to define a general L-shape. The lock arm 12 provides a generally centrally disposed lock slot 14 defining a hexagonal opening. The distal end of the key arm 16 provides a key slot 18 defined by four of the six sides of a hexagon cutout, or in other words a semi-hexagon cutout or notch.

A method of using the present invention may include the following. One or more jack screw locking devices 10 disclosed above may be provided. A user may crank the subject scissor jack 20 to the desired height and remove the crank wrench and observe if the crank nut 24 begins to unwind immediately. If not, then while holding one jack screw locking devices 10 horizontally so the lock arm 12 is closest and pointing down, the user can insert the key arm 16 into the jack frame just above the crank nut until the lock slot 14 slips over the crank nut 14. The scissor jack 20 is now locked in a locked engagement.

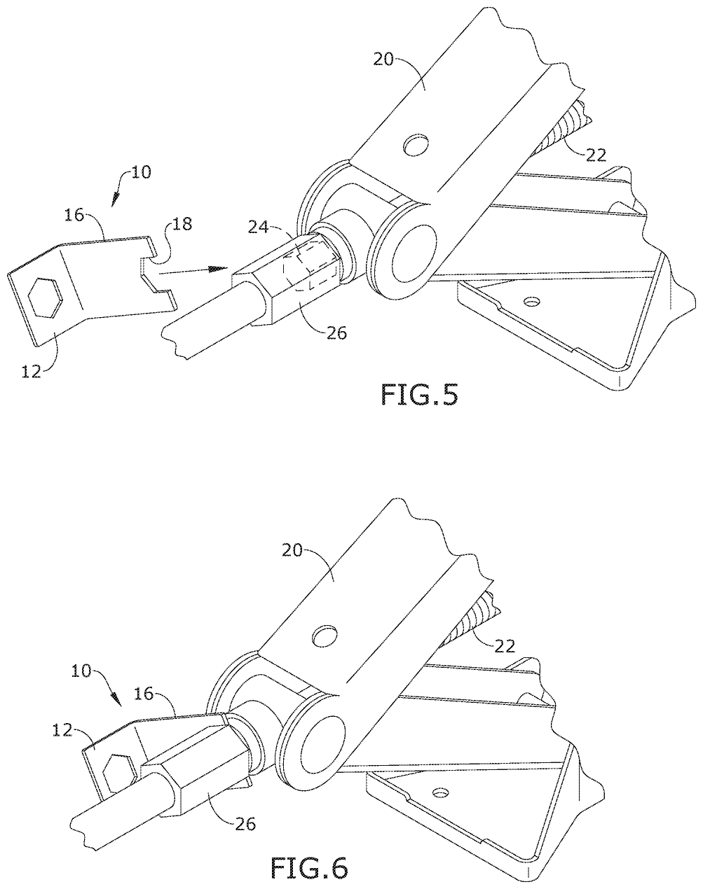

If immediate unwinding of the jack screw 22 occurs when the crank 26 is removed, but before the above-described locked engagement can be applied, the jack screw locking device 10 may be utilized as illustrated in FIGS. 5-7, and as follows: 1) the key slot 18 of a first jack screw locking device 10 is inserted behind the crank 26 to operatively associate with the jack screw nut 24 to hold the nut 24 from unwinding while the crank 26 is removed; and 2) a second jack screw locking devices 10 is then installed over the crank nut and into the scissor jack frame in the locked engagement described above. The first jack screw locking devices 10 that was used to hold the jack screw nut is removed and used elsewhere.

Note, the jack screw locking device 10 may be offered as a set of four identical devices, i.e., one for each corner scissor jack of an RV, whereas typically, only the rear two exhibit the tendency to loosen or unwind since the front two are augmented by a tongue jack, which is not subject to loosening.

The jack screw locking devices 10 may be made of metal or other form-able material. One could cut a blank rectangle in the specified dimensions from a sheet or extruded bar of the specified thickness, then punch or cut a hexagon hole of the specified dimension at one end of the blank at the specified location, then punch or cut an opening with parallel sides of the specified dimension at the other end of the blank at the specified location. The flat blank is then bent to 90 degrees in the specified location. The bracket is then de-burred. To make the present invention of plastic or other moldable material, an injection mold would be required to cast the device in one piece, including the hex hole, opening, and bend. The chosen material would have to be of sufficient strength so as to not tear or deform when used in the specified manner.

It should be understood, of course, that the foregoing relates to exemplary embodiments of the invention and that modifications may be made without departing from the spirit and scope of the invention as set forth in the following claims.

What is claimed is:

1. A jack screw locking device, comprising:
a lock arm providing a generally centrally disposed lock slot, wherein the lock slot is defined by a hexagonal opening;
a key arm orthogonally joined to the lock arm; and
a key slot provided at a distal end of the key arm, wherein the key slot is defined by a semi-hexagon notch.

2. The jack screw locking device of claim 1, wherein the lock slot and key slot are dimensioned and adapted to operatively associate with a jack screw nut of a scissor jack.

3. A method of positioning a scissor jack in a locked engagement, comprising:
providing a jack screw locking device of claim 1;
providing a scissor jack having a jack screw with a jack screw nut, wherein a frame of the scissor jack has a forked portion that operatively associates with the jack screw;
sliding the key arm between the forked portion; and
operatively associating the lock slot with the jack screw nut.

4. The method of claim 3, wherein the jack screw unloosens prior to establishing a locked engagement with said jack screw locking device, comprising:
providing a second jack screw locking device of claim 1; and
prior to sliding the key arm of said jack screw locking device, operatively engaging the jack screw nut and the key slot of the second jack screw locking device in a holding position.
